(19) United States
(12) Patent Application Publication
(10) Pub. No.: US 2007/0228115 A1
(43) Pub. Date: Oct. 4, 2007

(54) Method of manufacturing an electronic component

(75) Inventors: Teruji Inomata, Kanagawa (JP); Masatoshi Sugiura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/542,314

(22) Filed: Oct. 4, 2006

(30) Foreign Application Priority Data
Oct. 13, 2005 (JP) 2005-298789

(51) Int. Cl. B23K 31/02

(52) U.S. Cl. 228/231

(57) ABSTRACT

A method of manufacturing an electronic component which can reduce voids in a solder and can reliably melt the solder is provided. The method of manufacturing an electronic component including a member (substrate 1) having a metal junction (electrode 11) includes: the step of supplying a solder 5 containing a solvent, a resin component, an activator, and a brazing filler metal to the junction (electrode 11); the first heating step in which a first heating process to the solder 5 is performed and the solder 5 is kept at a first heating temperature for a predetermined period of time; the second heating step in which a second heating process to the solder 5 is preformed and the solder 5 is kept at a second heating temperature higher than the first heating temperature for a predetermined period of time to vaporize the solvent and the resin component; and the third heating step in which a third heating process to the solder 5 is performed and the solder 5 is melted.

This application is based on Japanese Patent application NO. 2005-298789, the content of which is incorporated hereinto by reference.

### BACKGROUND

1. Technical Field

The present invention relates to a method of manufacturing an electronic component.

2. Related Art

Solder is conventionally used in connection between members which constitute an electronic component.

For example, a first member and a second member constituting an electronic component are jointed to each other with a solder as described below.

A solder (conductive paste) is supplied onto a joint surface of the first member which constitutes the electronic component, and the second member which constitutes the electronic component is placed on the first member. Thereafter, the first member and the second member are preheated for a predetermined period of time at a temperature at which the solder does not melt.

The preheating is performed to uniform the temperatures of the first member and the second member.

Upon completion of the preheating, the temperature of the solder is increased, and main heating to melt the solder is performed.

Thereafter, the solder is cooled to joint the first member and the second member with the solder (for example, see Japanese Laid-open patent publication No. 2004-6682).

The following method is also proposed. That is, after a solder is supplied onto a first member, preheating is performed to the solder, and a solvent in the solder is vaporized. Thereafter, the solder is heated to a temperature equal to or higher than the melting point of it to melt the solder, and a second member is jointed (for example, see Japanese Laid-open patent publication No. 2000-68639).

Furthermore, the following method is also proposed. A first member and a second member are arranged so that a solder interposes between them, and heated to vaporize a flux. Thereafter, the solder is gradually melted (see Japanese Laid-open patent publication No. 8-281421).

However, the techniques described in the above references bear improvements with respect to the following points.

In the techniques described in Japanese Laid-open patent publication Nos. 2004-6682, 2000-68639, and 8-281421, a large number of voids may be generated in a solder which connects a first member and a second member to each other, and the number of voids is difficult to be reduced. When a large number of voids are present in the solder, the reliability in connection between the first member and the second member may be deteriorated.

In the techniques described in Japanese Laid-open patent publication Nos. 2004-6682, 2000-68639, and 8-281421, a solder may be difficult to be melted.

The above problems are posed not only when a first member and a second member constituting an electronic component are connected to each other with a solder, but also when solder bumps are formed on a member constituting an electronic component according to the methods described in the above Japanese Laid-open patent publications. More specifically, since a large number of voids may remain in the solder and the solder may not sufficiently be melted, solder bumps having a desired shape may not be formed.

### SUMMARY OF THE INVENTION

In the technique described in Japanese Laid-open patent publication No. 2004-6682, the present inventors assume that the reason why the number of voids in a solder is difficult to be reduced is as follows.

In the technique in Japanese Laid-open patent publication No. 2004-6682, as shown in FIG. 3 in Japanese Laid-open patent publication No. 2004-6682, main heating is performed to generate voids in a solder in a melting state. In this description, the voids moves upward and removed from the solder to prevent the voids in the solder from remaining.

However, in order to remove the voids from the melted solder, the inner pressures of the voids must be higher than the surface tension of the voids. In order to increase the inner pressures, the solder must be heated to a temperature higher than the melting point of the solder. Thus, there is a possibility that the members constituting the electronic component cannot withstand the high temperature and may be deteriorated. For this reason, in the technique in Japanese Laid-open patent publication No. 2004-6682, it is considered that it is difficult to remove the voids from the solder. Therefore, the number of voids is difficult to be reduced.

In the technique described in Japanese Laid-open patent publication No. 2000-68639, the present inventors assume that the reason why the number of voids in a solder is difficult to be reduced is as follows.

Voids generated in a solder may be caused by both vaporizations of a solvent and a resin component in the solder.

In the technique described in this patent publication, although the solvent in the solder is vaporized by preheating, vaporization of the resin component in the solder is not considered at all. It is considered that the number of voids remaining in the solder is difficult to be sufficiently reduced.

In Japanese Laid-open patent publication No. 8-281421, although vaporization of a flux in a solder is described, it is not known whether a solvent or a resin component contained in the flux is vaporized. The present inventors consider that when only the solvent is vaporized, as in the case described in Japanese Laid-open patent publication No. 2000-68639, the number of voids remaining in the solder is difficult to be sufficiently reduced.

Furthermore, in the techniques described in the above Japanese Laid-open patent publications, the present inventors consider that the reason why the solder is not sufficiently melted is insufficient removal of an oxide film formed on a solder surface. The present inventors assume that that this oxide film formed on the solder surface may prevent the solder from being melted.

The present invention is made on the basis of the above knowledge and assumption.

According to the present invention, there is provided a method of manufacturing an electronic component including a member having a metal junction, comprising:

supplying a solder containing a solvent, a resin component, an activator, and a brazing filler metal to the junction;

a first heating in which a first heating process to the solder is performed and the solder is kept at a first heating temperature for a predetermined period of time;

a second heating in which a second heating process to the solder is performed and the solder is kept at a second heating temperature higher than the first heating temperature for a predetermined period of time to vaporize the solvent and the resin component; and

a third heating in which a third heating process to the solder is performed and the solder is melted.

The activator contained in the solder functions in a state a solvent is sufficiently contained in the solder to remove an oxide film formed on a solder surface.

According to the invention, the first heating temperature of the first heating is lower than the second heating temperature of the second heating in the vaporizing the solvent and the resin component in the solder. Therefore, in the first heating, since the solvent is sufficiently contained in the solder, the activator can sufficiently function, and the oxide film formed on the solder surface can be reliably removed. In this manner, the third heating process is performed, and the solder can be reliably melted in the third heating in which the solder is melted.

Furthermore, since the solder is kept at the first heating temperature for the predetermined period of time, the oxide film formed on the solder surface can be more reliably removed.

In the present invention, the second heating process is performed to vaporize the solvent and the resin component. For this reason, in the performing the third heating process and melting the solder, the solvent and the resin component rarely vaporized. Thus, the number of voids which are generated in the solder can be sufficiently reduced.

Furthermore, in the present invention, since the solder is kept at the second heating temperature for the predetermined period of time, the solvent and the resin component can be more reliably vaporized.

In this case, in the present invention, the first heating temperature may fall within a predetermined temperature range, and the temperature of the solder may vary to some extent within the range of the first heating temperature while the temperature of the solder is kept for the predetermined period of time.

Similarly, the second heating temperature may also fall within a predetermined range.

The second heating may include: heating a solder at a first-second heating temperature higher than a first heating temperature and keeping the solder at the temperature for a predetermined period of time to vaporize one of a solvent and a resin component; and heating the solder at a second-second heating temperature higher than the first second heating temperature and the first-second heating temperature and keeping the solder at the heating temperature for a predetermined period of time to vaporize the other of the solvent and the resin component.

According to the present invention, there is provided to a method of manufacturing an electronic component which can reduce voids in the solder to make it possible to reliably melt the solder.

### BRIEF DESCRIPTION OF THE DRAWINGS

The above and other objects, advantages and features of the present invention will be more apparent from the following description taken in conjunction with the accompanying drawings, in which:

FIGS. 1A to 1C are pattern diagrams showing steps in manufacturing solder bumps according to an embodiment of the present invention.

FIG. 2 is a pattern diagram showing a reflow furnace.

FIG. 3 is a graph showing a heating profile of a solder.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

An embodiment of the present invention will be described below with reference to the accompanying drawings.

An outline of the method of manufacturing an electronic component according to the embodiment will be described below.

The method of manufacturing an electronic component according to the embodiment is a method of manufacturing an electronic component including a member (substrate 1) having a metal junction (electrode 11), and includes: a step of supplying a solder 5 containing a solvent, a resin component, an activator, a thixotropic agent, and a brazing filler metal to the junction (electrode 11); a first heating step in which a first heating process to the solder 5 is performed and the solder is kept at a first heating temperature for a predetermined period of time; a second heating step in which a second heating process to the solder 5 is performed and the solder 5 is kept for a predetermined period of time at a second heating temperature higher than the first heating temperature to vaporize the solvent and the resin component; and a third heating step in which a third heating process to the solder is performed and the solder 5 is melted.

A method of manufacturing an electronic component will be described below.

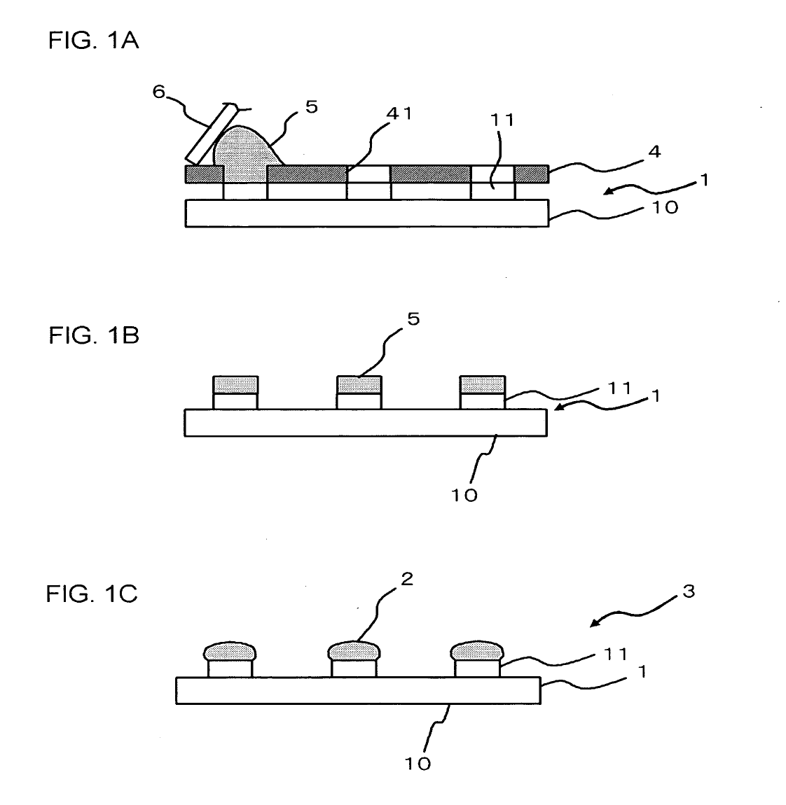

As shown in FIG. 1A, as a member constituting an electronic component, a substrate 1 having a base material such as silicon wafer and electrodes 11 formed on the base material 10 is prepared.

The substrate 1 may be a silicon interposer, a circuit board, or the like.

The electrode 11 is made of a metal and functions as a junction. A plurality of electrodes 11 are arranged.

A metal mask 4 having a plurality of openings 41 which correspond to an arrangement pattern of the electrodes 11 is prepared. The mask 4 is arranged on the substrate 1.

The solder 5 is coated on the metal mask 4. For example, the solder 5 is coated on the metal mask 4 by using a squeegee 6. In this manner, the solder 5 is filled in the openings 41 of the metal mask 4 and is supplied onto the electrodes 11 of the substrate 1 which serve as a junction.

In this case, the solder 5 contains a solvent, a resin component, an activator, a thixotropic agent, and a brazing filler metal.

A flux consists of the solvent, the resin component, the activator, and the thixotropic agent.

Solvents include an organic solvent. The solvent may consist of one type of an organic agent, or may contain different types of organic solvents.

Resin components include, for example, a natural resin such as rosin, a rosin modified derivative, a synthetic resin such as a phenol resin, an acrylic resin, and the like.

An activator is to remove an oxide film formed on the solder surface. For example, the activator comprises an organic acid salt (organic amine hydrochloride) or a hydrogen halide salt.

Brazing filler metals include, for example, lead, silver, copper, phosphoric copper, aluminum, nickel, tin, and the like. These materials can be used alone or in combination with two or more materials.

A brazing filler metal containing 85% or more lead by weight and 15% or less tin % by weight (so-called high-temperature solder) is preferably used.

The metal mask 4 is removed from the substrate 1. In this manner, as shown in FIG. 1B, a state in which the solder 5 is printed on the electrode 11 is obtained.

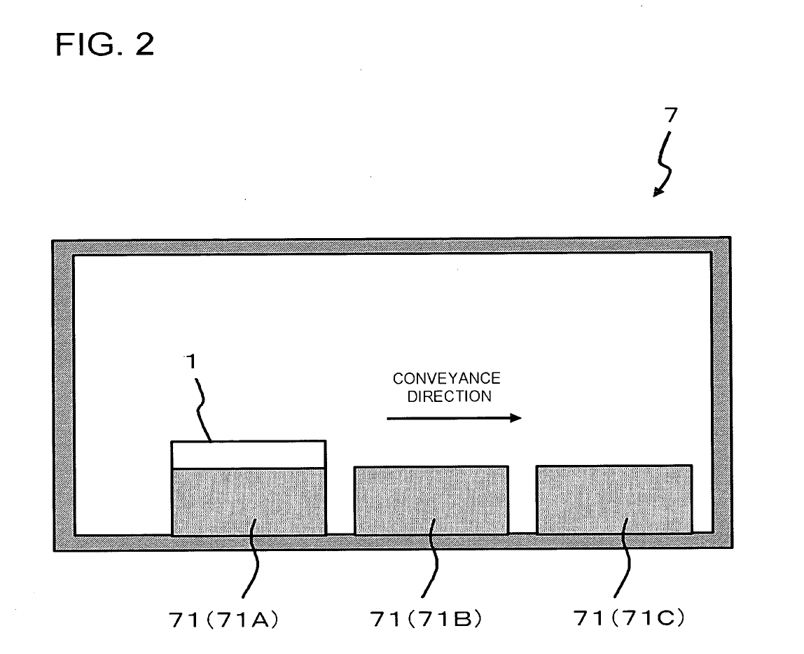

The substrate 1 on which the solder 5 is printed is sent to a reflow furnace 7 as shown in FIG. 2 and heated.

In this case, an atmosphere in the reflow furnace 7 is a low-oxygen atmosphere having an oxygen concentration which is lower than that of the air outside the reflow furnace 7. In the reflow furnace 7, a plurality of heaters 71 (71A, 71B, and 71C) which are set at different temperatures respectively are arranged. The substrate 1 is placed on each of the heaters 71 by a conveyer (not shown) to heat the solder 5.

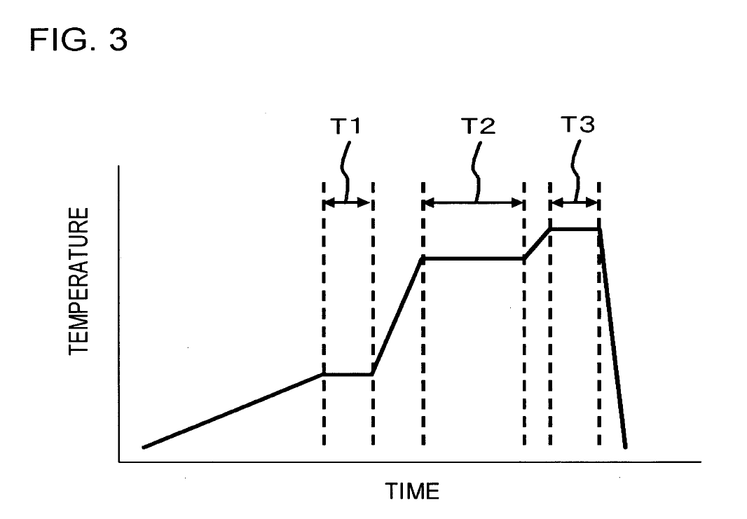

In this case, a heating profile of the solder 5 is as shown in FIG. 3.

The substrate 1 is placed on the first heater 71A. The solder 5 is heated by the first heater 71A (a first heating process). In this manner, the temperature of the solder 5 is increased to a first heating temperature. At the first heating temperature, the solvent and the resin component in the solder 5 are rarely vaporized, and the solvent and the resin component in the solder 5 are suppressed from being vaporized. In this case, the first heating temperature is, for example, about 140oC to 170oC, depending on types of a solvent, a resin component and a brazing filler metal in the solder 5.

When the temperature of the solder 5 reaches the first heating temperature, the solder 5 is kept at the first heating temperature for a predetermined period of time. For example, the solder 5 is kept at the first heating temperature for 30 seconds to 120 seconds (T1=30 seconds to 120 seconds in FIG. 3). While the solder 5 is kept at the first heating temperature for the predetermined period of time, the temperature of the solder 5 may vary to some extent within the range of the first heating temperature.

In the first heating step, the solder 5 is kept at the first heating temperature for the predetermined period of time to activate the activator in the solder 5 and the resin component in the solder 5, so that an oxide film on the surface of the solder 5 is removed.

In this case, since the atmosphere in the reflow furnace 7 is in low-oxygen state as described above, it is considered that an oxide film is rarely formed on the surface of the solder 5 again after the oxide film on the surface of the solder 5 is removed.

Thereafter, the substrate 1 is conveyed onto the second heater 71B by a conveyer (not shown). A temperature of the second heater 71B is set at a temperature higher than the temperature of the first heater 71A.

When the substrate 1 is placed on the second heater 71B, the substrate 1 is heated to perform a heating process (a second heating process) to the solder 5. In this manner, the temperature of the solder 5 increases to a second heating temperature higher than the first heating temperature. The second heating temperature is a temperature at which both the solvent and the resin component in the solder 5 are vaporized and a temperature which is lower than the melting point of the solder 5.

The solder 5 is kept at the second heating temperature for a predetermined period of time (for example, T2=30 seconds or more and 90 seconds or less in FIG. 3) to vaporize the solvent and the resin component in the solder 5 (a second heating step).

In this case, the second heating temperature is set at, for example, 290oC or more and less than the melting point of the solder 5, depending on the types of a solvent, a resin component, a brazing filler metal, and the like in the solder 5.

While the solder 5 is kept at the second heating temperature for the predetermined period of time, the temperature of the solder may vary to some extent within the range of the second heating temperature.

The substrate 1 is conveyed onto the third heater 71C by a conveyer (not shown). A temperature of the third heater 71C is set at a temperature higher than the temperature of the second heater 71B.

When the substrate 1 is placed on the third heater 71C, a heating process (a third heating process) to the solder 5 is performed. In this manner, the temperature of the solder 5 is equal to or higher than the melting point of the solder 5.

In this case, when the solder 5 which contains a brazing filler metal containing 85% or more lead and 15% or less tin is used, the temperature of the solder 5 is set at, for example 300oC or more (a third heating step).

In this manner, the solder 5 is melted to joint the electrode 11 and the solder 5 on the base material 10.

After the solder 5 is heated at the melting point or higher for a predetermined period of time (T3 in FIG. 3), the substrate 1 is removed from the third heater 71C by the conveyer to gradually cool the solder 5. In this manner, the solder 5 on the electrode 11 solidifies to form a solder bump 2 having a desired shapes as shown in FIG. 1C. More specifically, a semiconductor device (electronic component) 3 having the substrate 1 and the solder bumps 2 formed on the electrode 11 of the substrate 1 can be obtained.

An effect of the embodiment will be described below.

The activator contained in the solder 5 functions in a state in which the solvent is sufficiently contained in the solder 5 to remove an oxide film formed on the surface of the solder 5.

In the embodiment, the solder 5 is heated at the first heating temperature lower than the second heating temperature of the second heating step in which the solvent and the resin component in the solder 5 are vaporized. For this reason, in the first heating step in which the solder 5 is kept at the first heating temperature for the predetermined period of time, since the solvent is sufficiently present, the activator can sufficiently function. As a result, the oxide film formed on the surface of the solder 5 can be reliably removed.

In the first heating step in which the solder 5 is kept at the first heating temperature for the predetermined period of time, since the solder 5 is heated at the first heating temperature lower than the second heating temperature, the resin component in the solder 5 is rarely vaporized. For this reason, the oxide film formed on the surface of the solder 5 can also be reliably removed by the operation of the resin component.

Furthermore, in the embodiment, since the solder 5 is kept at the first heating temperature for the predetermined period of time, the oxide film formed on the surface of the solder 5 can be more reliably removed.

In this manner, since the oxide film on the surface of the solder 5 can be reliably removed, in the step of melting the solder 5, the solder 5 can be reliably melted.

Thus, the solder bumps 2 having a desired shape can be formed.

In the embodiment, the solder 5 is kept at the second heating temperature lower than the melting point of the solder 5 for the predetermined period of time to vaporize the solvent and the resin component. Accordingly, when the solder 5 is melted, the solvent and the resin component are rarely vaporized.

In this manner, since both the solvent and the resin component can be prevented from being vaporized when the solder 5 is melted, the number of voids formed in the solder (solder bumps 2 in this case) can be sufficiently reduced.

Since the solder 5 is kept at the second heating temperature for the predetermined period of time, the solvent and the resin component can be more reliably vaporized.

Accordingly, in the embodiment, since the number of voids in the solder bump 2 can be sufficiently reduced, a void inspection step which is conventionally performed after the solder bumps 2 are formed can be omitted. In this manner, time required to manufacture a semiconductor device can also be shortened.

In order to remove the voids in the solder bump 2, a vacuum reflow furnace may be used. However, the vacuum reflow furnace is expensive, and the manufacturing cost of semiconductor devices increases.

In contrast to this, in the embodiment, the conventional reflow furnace 7 can be used. Voids in the solder bumps 2 can be removed only by controlling the temperature of the heaters 71 (71A, 71B, and 71C) in the reflow furnace 7. Thus, increase of the manufacturing cost of the semiconductor device 3 can be prevented.

The present invention is not limited to the above embodiment. Changes, modifications, and the like made within a range in which the object of the present invention can be achieved are included in the scope of the present invention.

In the embodiment, the first heating temperature, the second heating temperature, and the third heating temperature are exemplified. However, these are not limited to the temperatures described above. The first heating temperature, the second heating temperature, and the third heating temperature may be appropriately set depending on the types of a solvent, a resin component, a brazing filler metal, and an activator constituting a solder, a material of a member onto which the solder is applied, or the like.

In the embodiment, solder bumps 2 are formed on the substrate 1. However, the present invention is not limited to the configuration of the embodiment. By using the method of manufacturing an electronic component according to the present invention, for example, the substrate 1 having the electrodes 11 serving as metal junctions and a semiconductor package having terminals serving as metal junctions may be connected to each other by a solder to manufacture a semiconductor device as a electric component.

More specifically, in a state in which a solder is melted on the junctions (electrodes 11) of a member (substrate 1) having metal junctions (electrodes 11), metal junctions (terminals) of another member (a semiconductor package) are brought into contact with the solder to solder the other member (a semiconductor package).

Furthermore, in the embodiment, the reflow furnace 7 having the plurality of heaters 71 (71A, 71B, and 71C) is used to form the solder bumps 2. However, the present invention is not limited to the configuration of the embodiment. A reflow furnace having only one heater may be used. In this case, the temperature of the heater may be increased and controlled to perform a heating process of solder.

In the embodiment, in the second heating step, the solvent and the resin component in the solder 5 are vaporized at the same temperature. However, the present invention is not limited to the configuration of the embodiment. For example, when the solvent and the resin component in the solder 5 are vaporized at largely different temperatures (for example, when the peak of a volatile temperature of the solvent is considerably lower than that of the resin component), the solder may be heated for a predetermined period of time in the vicinity of a temperature which shows a peak of melting of the solvent and then heated for a predetermined period of time in the vicinity of a temperature which shows a peak of melting of the resin component.

In other word, the second heating step of the present invention may include two heating steps. The second heating step may include the step of heating a solder at a first-second heating temperature (a peak volatile temperature of the solvent) higher than the first heating temperature and keeping the solder at the temperature for the predetermined period of time, and the step of heating the solder at the second-second heating temperature (a peak volatile temperature of the resin component) higher than the first heating temperature and the first-second heating temperature and keeping the solder at the temperature for a predetermined period of time.

However, when the solder is heated at the temperature which is almost equal to the peak volatile temperature of the resin component for the predetermined period of time, it is considered that the solvent is also vaporized as a matter of course. For this reason, it is considered that both the resin component and the solvent can be sufficiently vaporized by only heating the solder at a peak volatile temperature of the resin component (a higher peak temperature of peak volatile temperatures of the resin component and the solvent).

### EXAMPLE

An example of the present invention will be described below.

As in the above embodiment, a substrate which comprises a base material which is a silicon wafer and electrodes formed on the base material was prepared.

A solder was printed on the electrodes of the substrate by the same method as that in the embodiment.

As the solder, a solder containing a solvent (organic solvent), a resin component (rosin), an activator (organic amine hydrochloride), a thixotropic agent, and a brazing filler metal (95% lead by weight and 5% tin by weight) was used.

As in the above embodiment, the solder was heated to form a solder bump.

In this case, a first heating temperature for the solder was set at 140oC to 170oC. The first heating temperature was kept for 30 seconds to 120 seconds.

A second heating temperature for the solder was set at 290oC or more and lower than the melting point of the solder. The solder was kept at the second heating temperature for 30 seconds or more and 90 second or less.

In the step of melting the solder, the temperature of the solder was set at 308oC or more.

In this example, the solder was able to be melted, and the shapes of the formed solder bumps were semispherical. Thus, desired shapes were obtained.

It is assumed that this effect was caused by the following reasons. That is, when the solder is heated at the first heating temperature for a predetermined period of time, since the solvent and the resin component are rarely vaporized and suppressed from being vaporized, the activator sufficiently functions to remove an oxide film on a solder surface.

Voids in each solder bumps were observed by an X-ray inspection device.

By using an X-ray transmission image of the X-ray inspection device, voids which have an area of 10% or more of the area of the solder bump, which is considered to adversely affect connection reliability were counted.

In this case, there was no void having the area of 10% or more of the area of the solder bump. Thus, a generation ratio of voids was 0%.

The solder was heated at the second heating temperature for the predetermined period of time to sufficiently vaporize the solvent and the resin component. Therefore, it is considered that the void having the area of 10% or more of the area of the solder bump was not generated.

An X-ray inspection device used in Example has an X-ray generator which irradiates an X-ray to a substrate on which solder bumps are formed, an X-ray transmission image generating device which detects a transmission image of an X-ray emitted from the X-ray generator and transmitted through the substrate, and the like.

### Comparative Example

The same substrate as in Example was prepared, and, as in Example, solders were printed on electrodes on the substrate.

In the Comparative Example, a second heating process is not performed to the solders, and the solder were not kept at the second heating temperature for the predetermined period of time. The other points are the same as those in the above Example.

Voids in each solder bumps were observed by the same X-ray inspection device as that in the above Example. In an X-ray transmission image, voids having an area of 10% or more of the area of the solder bump were counted. As a result, a generation ratio of the voids having the area of 10% or more of the area of the solder bump ((the number of solder bumps in which voids are generated)/(the total number of bumps)) was 2.2%.

In the Comparative Example, the second heating process was not performed to the solder, and the solder was not kept at the second heating temperature for the predetermined period of time. Accordingly, it is considered that the solder was melted in a state in which the solvent and the resin component were not sufficiently vaporized, and thus considered that a large number of voids were generated.

It is apparent that the present invention is not limited to the above embodiment, that may be modified and changed without departing from the scope and spirit of the invention.

What is claimed is:

1. A method of manufacturing an electronic component including a member having a metal junction, comprising:
supplying a solder containing a solvent, a resin component, an activator, and a brazing filler metal to said junction;
performing a first heating process to said solder, said solder is kept at a first heating temperature for a predetermined period of time in said first heating process;
performing a second heating process to said solder, said solder is kept at a second heating temperature higher than the first heating temperature for a predetermined period of time to vaporize said solvent and said resin component in said second heating process; and
performing a third heating process to said solder, said solder is melted in said third heating process.

2. The method according to claim 1, wherein in said first heating process, an oxide film formed on the solder surface is removed.

3. The method according to claim 2, wherein in said first heating process, the oxide film formed on the solder surface is removed while the solvent and the resin component contained in the solder are suppressed from being vaporized.

4. The method according to claim 1, wherein said second heating temperature is less than a melting point of said solder.

5. The method according to claim 1, wherein said member is a substrate having an electrode as said junction, and
said electronic component is a semiconductor device having said substrate and a solder bump formed on the electrode of said substrate.

6. The method according to claim 1, wherein said first heating process, said second heating process, and said third heating process are performed in a low-oxygen atmosphere having an oxygen concentration lower than that of the air.
